(19) United States
(12) Patent Application Publication
(10) Pub. No.: US 2004/0195049 A1
(43) Pub. Date: Oct. 7, 2004

(54) Cab construction

(76) Inventors: Alexander Stobo, Orangeville (CA); Donald E. Cation, Georgetown (CA); Danny Duarte, Brampton (CA); Paul Norman Crews, Brampton (CA); Brian D. Sheldrick, Wasaga Beach (CA); Everett W. Roberts, Erin (CA); Darryl J. Greenaway, Wasaga Beach (CA); David E. Kairis, Brampton (CA); David L. Morey, Georgetown (CA)

Correspondence Address: PEARNE & GORDON LLP, 1801 EAST 9TH STREET, SUITE 1200, CLEVELAND, OH, 44114-3108, US

(21) Appl. No.: 10/391,248

(22) Filed: Mar. 18, 2003

(51) Int. Cl. B66B 11/02

(52) U.S. Cl. 187/401

(57) ABSTRACT

An elevator cab constructed in-situ from elongated channel shaped pans. The pans have their ends bolted to steel alignment angles and their flanges bolted to abutting flanges of adjacent pans. The pans and alignment angles can be bolted together with bolts and nuts of a common size and preferably are arranged to rotationally interlock with the bolts to simplify tightening of the nuts and enable the cab to be conveniently assembled even in low clearance hoistways. Light fixtures are nested in associated pans forming the cab top and are protected by sheet metal panels secured to the flanges of such pans. An emergency exit door on a top panel has a unique safety switch interlock.

### BACKGROUND OF THE INVENTION

The invention relates to elevator cab construction and, in particular, to cabs of the type assembled from a plurality of steel panels.

### PRIOR ART

Elevator cabs or cars are typically erected within a hoistway or shaft because ordinarily the landing openings to the shaft are roughed in or finished before the car is on site and because the openings are smaller than the size of the cab. It is a common practice to construct the cab of sheet metal panels small enough to be easily passed through a landing opening. Various structural designs have been developed for in-situ erection of a cab. These designs may have a structural steel skeletal framework or may rely on the panels themselves for requisite strength and stiffness. Where the space in a hoistway is limited in relation to the size of the cab, it may be difficult and time consuming to assemble prior art cabs. More specifically, there may be very limited space between the walls of the hoistway and the walls of the cab making it difficult to obtain comfortable access or to manipulate wrenches or other tools. Such tight quarters, additionally, can make it difficult or impossible to gain a clear line of sight where parts or fasteners need to be aligned and assembled.

### SUMMARY OF THE INVENTION

The invention provides an elevator cab construction that is economical to fabricate, simple and quick to install and rugged in service. The cab construction involves a unique combination of elements that can be readily assembled by a workman even without previous experience and without extraordinary skill or dexterity and yet obtains a rugged unit with a quality fit. The basic elements of the cab are a plurality of elongated steel pans that, assembled together, make up the sidewalls and top of the cab. The panels are conveniently and correctly aligned with steel angles located at both of their ends.

The alignment angles are factory formed with holes for fasteners that join the angles and panels together. A feature of the cab construction is an arrangement by which the various panels and angles of the cab are adapted to accept identical fasteners in both panel-to-panel joints and panel-to-angle joints. This feature simplifies the job of the installer since only one supply of fasteners need be carried and a single size wrench can be used to effectuate assembly of the cab.

A further enhancement of the common fastener feature is the provision of accircular holes in the form of squares or slots in both the pans and the angles and the use of carriage bolts or like bolts dimensioned to rotationally interlock with the accircular holes. This combination enables the bolts to be tightened with a single wrench without difficulty and avoids the need to use both hands to accomplish the same. Where clearances between the cab and walls of the hoistway are close, the ability to complete the bolt tightening process with one hand can be a significant advantage.

Steel alignment angles are used to set the location of the cab walls on an elevator platform. This ensures that the walls are erected along straight, parallel or perpendicular lines. These platform or bottom angles have precisely located factory formed holes for joining the wall panels in an error free manner. Preferably, the angles are mounted on the platform by first positioning them in a specified location, temporarily holding them in this position and drilling and tapping them in-situ simultaneously with the platform. Ideally, this is accomplished with self-tapping bolts. The described technique eliminates a troublesome need to correlate mounting holes in the platform, which is ordinarily built by a manufacturer other than the cab supplier, with holes in the bottom alignment angles of the cab.

The disclosed cab can be advantageously erected by a workman standing or otherwise supported on the elevator platform essentially within the space being enclosed by the cab or on top of the cab. Thus, the assembly process is substantially unhindered by relatively close clearances between the cab and the hoistway.

The various panels that make up the cab have a simple C-channel geometry that is inexpensive to fabricate, rugged enough to avoid damage in shipping, handling and expected service conditions and strong enough in service to avoid the need for a separate skeletal framework. A simple numbering system of the panels can be followed to ensure a fast, mistake proof assembly of the cab. The top panels of the cab have a deep section that lends itself to a readily protected recessed lighting system. An emergency exit door in a top panel has a safety switch arrangement that is wholly insensitive to panel distortion, misalignment, and moderate damage.

### BRIEF DESCRIPTION OF THE DRAWINGS

FIG. 1 is an isometric view of a cab constructed in accordance with the invention on a platform and with a small portion of a side pan broken away to reveal part of a bottom alignment angle;

FIG. 2 is a fragmentary isometric view of a right bottom alignment angle and a typical bolt used to assemble these elements together;

FIG. 3 is a fragmentary isometric detail view of the intersection of the right bottom angle and a rear bottom angle;

FIG. 4 is an isometric view of a right rear corner of the cab being formed by intersecting wall pans;

FIG. 5 is an isometric view of the assembly of the sidewall pans of the cab;

FIG. 6 is a fragmentary exploded view of the assembly of a typical top alignment angle and side pans;

FIG. 7 is a fragmentary exploded view of portions of a top pan being assembled to a top angle;

FIG. 8 is a fragmentary cross-sectional view of top pans, a light fixture and a protective panel taken in the plane indicated at 8-8 in FIG. 1; and

FIG. 9 is an isometric view of an emergency exit door and a safety switch.

### DESCRIPTION OF THE PREFERRED EMBODIMENT

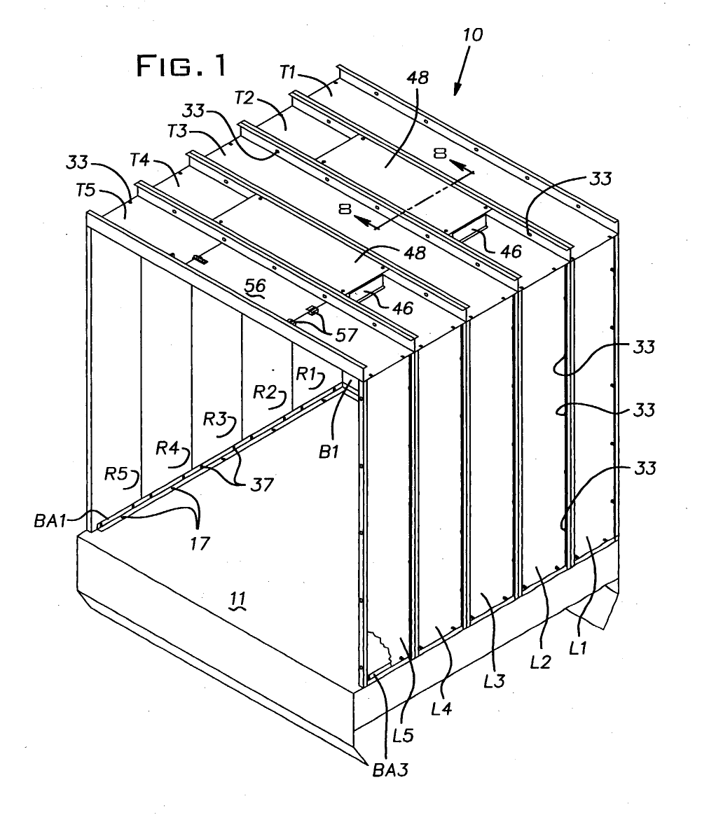

FIG. 1 illustrates an elevator cab or car 10 constructed in accordance with the invention. The cab 10 is assembled on a conventional platform 11 usually supplied by the source of the lift mechanism, typically a hydraulic cylinder below the platform or an electric hoist at the top of a hoistway or shaft as is known in the industry. The cab 10 is formed primarily of elongated pans or panels B1-6, R1-5, L1-5 and T1-5 with C-shaped channel cross-sections and steel angle pieces BA1-3 and TA1-3 that serve to align and interconnect the panels.

The lengths of the three sets of angles BA, TA, determined at the cab factory or shop, correspond to the inside plan dimensions of the cab 10. FIG. 3 illustrates how a bottom side angle BA1 interfits with a rear bottom angle BA2. Another side bottom angle BA3 interfits with the rear or back bottom angle BA2 in the same way. The angles BA1-3 are formed with accircular holes 16, such as the illustrated square holes, at the cab factory. It will be seen that the location of the holes 16 corresponds to the eventual location of mating holes in the side panels B, R and L.

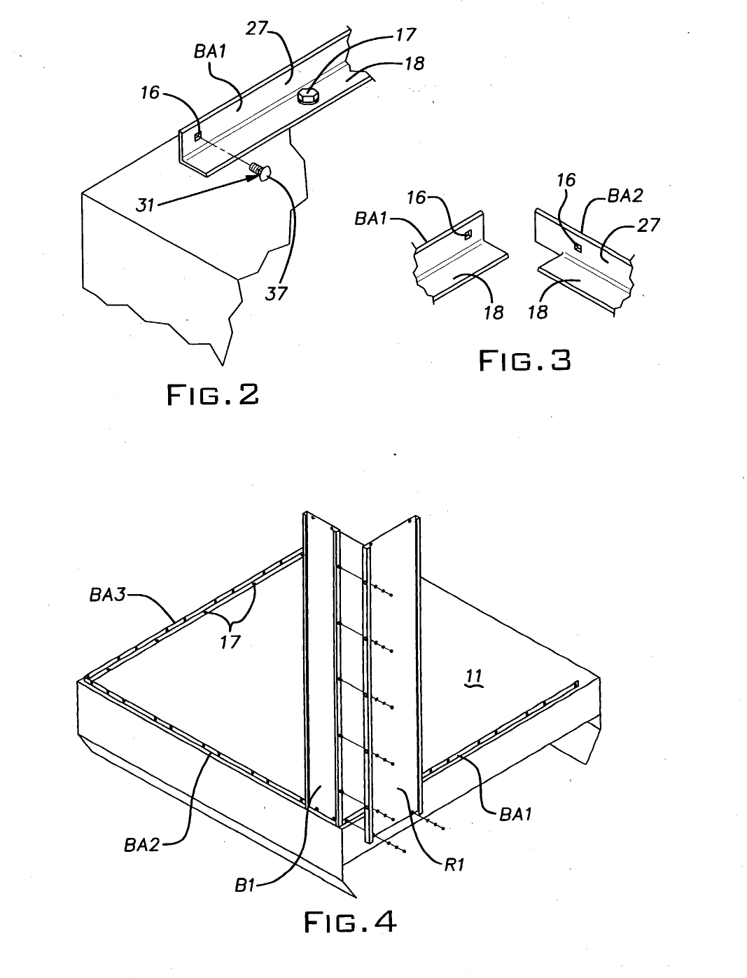

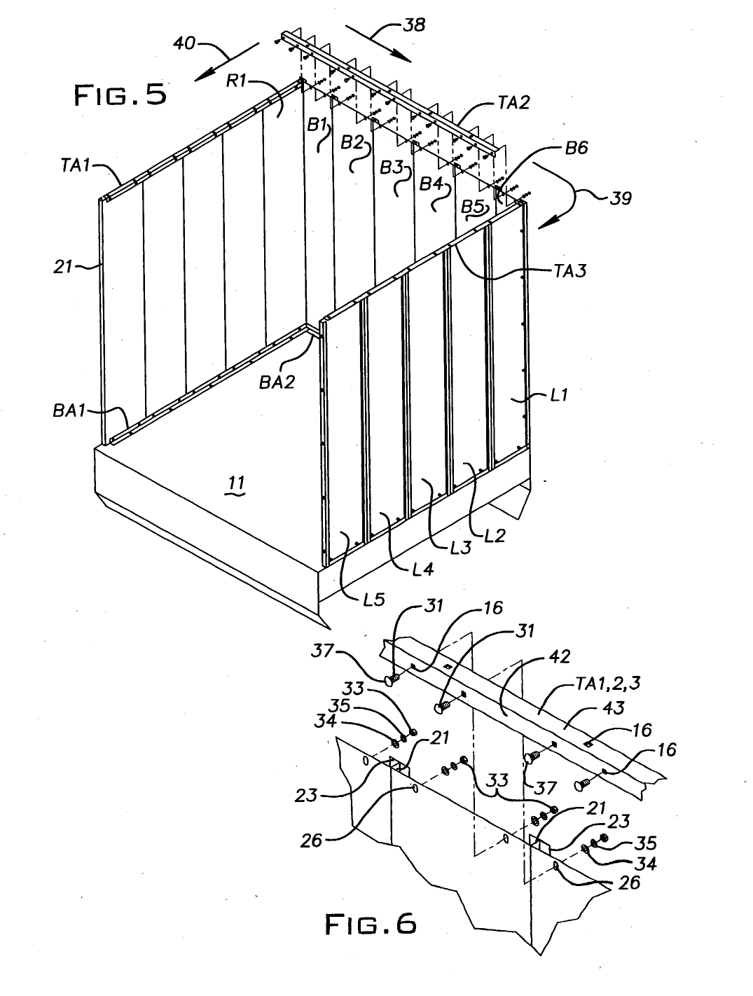

With reference to FIG. 4, the bottom or platform angles BA1-3 are properly located on the platform 11 with appropriate measurements being made and are preferably held temporarily in place by clamps or other suitable means. Once the angles BA1-3 are temporarily fixed in position, self-tapping bolts 17, known in the trade, are driven into lower horizontally extending legs 18 of the angles and the underlying platform 11 (FIG. 2). Undersize holes for receiving the bolts 17 can first be drilled in situ through the angle legs 18 and the platform 11, if desired or necessary, for reception of the bolts 17. These operations can be performed by the workman installing the cab exclusively from the topside of the platform 11. Since the bolts 17 are spotted after the angles BA are properly located, there is no critical correlation of holes in the platform 11 and holes in the angles BA.

The angles BA1-3 serve to align the bottoms of the side panels B, R, L along straight lines and rigidly fix them to the platform 11.

The side and top pans B, R, L and T are preferably formed of steel sheets of, for example, 14 gauge stock painted after their fabrication into pans of C-shaped cross-section. The pans B, R, L and T are economically formed in a press brake, for example, and include flanges or legs 21, 22 and returns or lips 23, 24. The pans B, R, L, T, preferably have a nominal width of, for example, about 18″ or similar dimension so that they are comfortably spanned by the arm of a workman to enable them to be bolted together. The pans B, R, L, T have factory or shop made accircular holes, in the form of oblong slots 26 spaced along their flanges 21, 22 and adjacent their end edges.

FIG. 4 illustrates the initial steps in assembling the side pans B1, R1 to the bottom platform angles BA2, BA1, respectively.

The pans B1, R1 are assembled against outward faces of vertical legs 27 of the bottom angles BA1-3. Preferably, at the corners of the cab 10, where left and right side pans L1 and R1 and back pans B1, B6 intersect, the back pans B1, B6 have bolts 31 assembled and factory welded in respective slots 26 to facilitate their assembly with the side panels R1, L1.

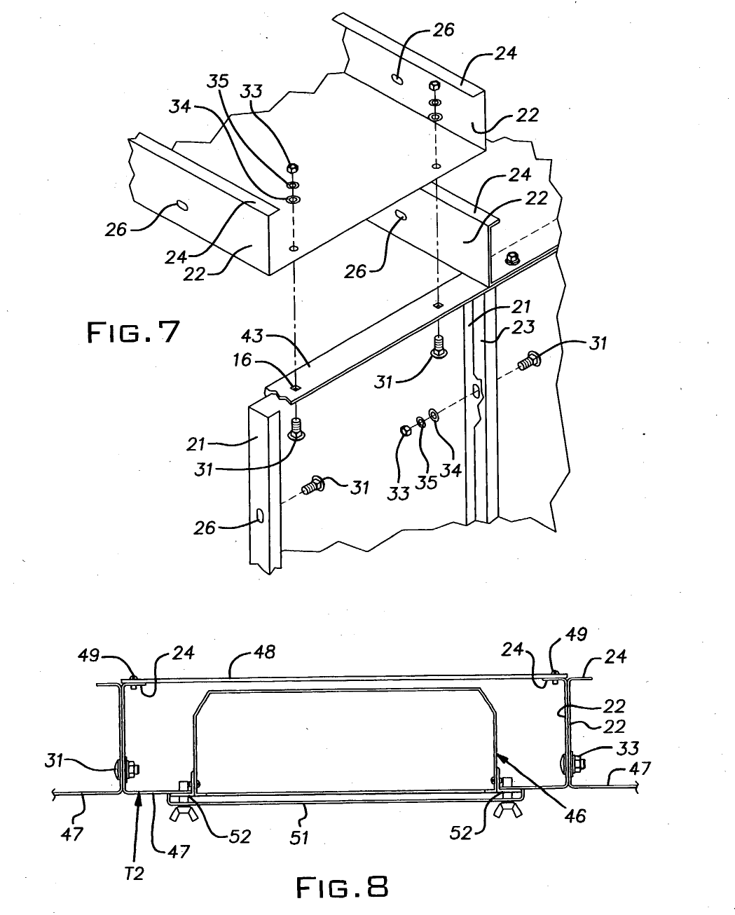

The square holes 16 in the angles BA1-3 (as well as in top angles TA1-3 to be discussed) and slots 26 in the pan ends and flanges 21, 22, are all dimensioned to receive a common size of bolt 31. More particularly, these accircular holes 16, 26 are dimensioned to receive the square shank section of a carriage bolt, step bolt or other like bolt such as a countersunk square bolt or an elevator bolt. The bolts 31 in the preferred embodiment are ⅜-16×¾″ long carriage bolts. The holes 16 can be 7/16″ square and the oblong slots can be 7/16″ wide by ¾″ long. These 7/16″ dimensions of the holes 16, 26, enable them to receive and rotationally interlock with a square 32 (e.g. FIG. 7) on a shank under the head of the carriage bolt 31. Similarly, nuts 33 used with the bolts 31 are a common size, e.g. ⅜″-16 hex nuts. Note also that nominal ⅜″ flat washers and ⅜″ lock washers 34, 35 are also used in assembling the pans and angles

The common bolt, nut and washer size used to join the pans B, R, L, T and angles BA, TA, contributes to the simplicity and ease of assembly of the cab 10 since an installer need only carry a single supply of bolts, nuts and washers and a single wrench. The rotational interlock of the carriage bolts 31 and the holes 16, 26 advantageously avoids the need for a second wrench to hold the bolt 31 against rotation.

By starting the assembly of side pans R1, B1 at a corner of the car, these two intersecting pans stabilize each other to enable them to remain vertical. It will be understood from FIG. 4, that the bolts 31 and nuts 33 at the bottom edges of the pans and the nuts on the vertical edges of the side panel R1 can be assembled by the installer while he remains on the platform 11 since the width of the pans is less than an arms reach of a typical adult workman. The bolts 31 at the bottom or platform angle BA are assembled through the angle BA1-3 first and then the pan B, R and L so that the round head, designated 37 is on the inside of the completed cab and a flat washer 34, lock washer 35 and nut 33 are on the outside of the cab. Arrows 38, 39 and 40 show the progression of assembly of the side pans B, R and L. For example, pan B2 is bolted to pan B1 and pan B3 is bolted to pan B2 and so forth. The installer can easily reach the slotted holes 26 along the abutting vertical flanges or legs 21 of the previous and new pans being assembled while standing or otherwise being supported on the platform 11 to assemble the bolts 31, washers 34, 35 and nuts 33 and to tighten the same. The pan B6, like pan B1, ideally has its bolts 31 welded in place at the factory to facilitate attachment of pan L1 thereto.

After all of the side pans B, R, L are secured to the platform bottom angles BA and to each other, as shown in FIGS. 5 and 6 upper steel angles TA are assembled on the upper ends of the pans. Like the bottom angles BA, the top angles TA are factory formed with 7/16 square holes 16 on both of their legs 42, 43 at appropriate centers to align with the slots 26 in the ends of the side pans as well as the slots 26 in the ends of the top pans. As shown most clearly in FIG. 6, the angles TA are assembled with a vertical leg 42 on the inside of the pans B, R, L and a horizontal leg 43 extending over the ends of the side pans. The bottom angles BA and top angles TA can be fabricated, for example, out of 2″×2″×3/16″ structural steel angle. The top angles TA are fixed to respective side pans B, R, L with carriage bolts 31 assembled through the holes 16 in the angle legs 42 and then through the holes 26 in the pans. This procedure, again, can be accomplished by an installer supported in the space on the platform 11 to be enclosed by the cab 10. The top angles TA serve to align the upper ends of their associated side pans, B, R, L along straight lines so as to assure a quality fit and finish. Once the top angles TA are bolted to the pans B, R, L, the top pans T can be successively bolted in place starting with T1. The orientation of the top angles TA with their horizontal legs 43 extending outward from the interior of the cab 10 enables a single workman or installer, working either in the cab space or on top of the top of the previously installed top panels T to easily assemble bolts through the holes 16 in the horizontal legs 43 of the top angles TA. Adjacent top pans T are secured together with bolts 31, washers 34, 35, and nuts 33, the bolts being received and rotationally locked in aligned accircular holes or slots 26 in their abutting flanges 22.

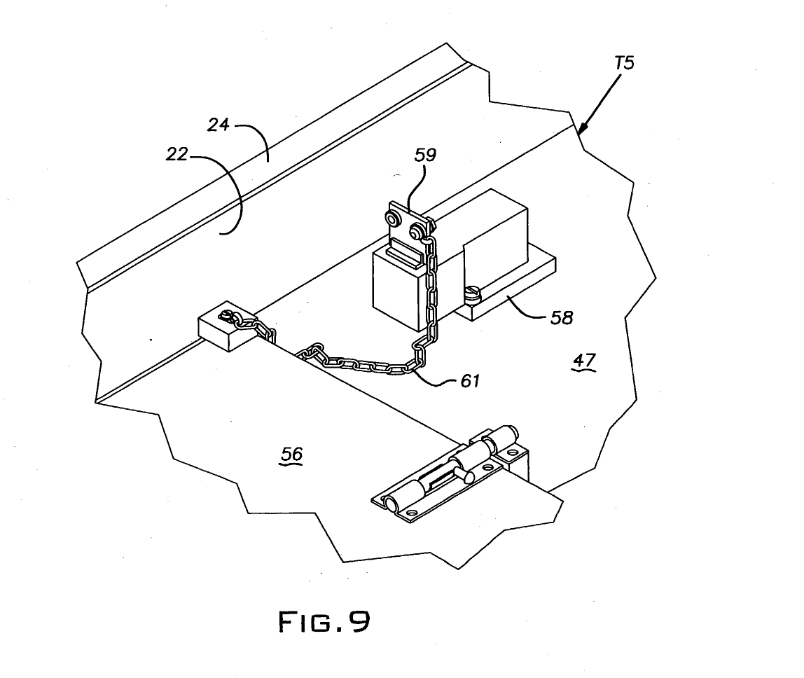

The top pans T are typically assembled starting at the back or rear and working towards the front. The top pans T have a deeper cross-section than the side pans B, R, L by virtue of having wider flanges or legs 22 (for example, 4-½″ as compared to 1-¾″) and, are correspondingly stronger so as to support a workman on the top of the cab. The deep section of the top pans T enables recessed light fixtures 46 such as standard fluorescent fixtures to be received within the space bounded by the web, designated 47, legs or flanges 22 and returns 24 of a top panel as shown in FIG. 8. The fixture 46 is shielded from above against a workman inadvertently stepping on the fixture or other potential damage by a stiff steel panel 48. The panel 48 is retained in place and supported on the returns or lips 24 of the associated pan T2 or T4 by sheet metal screws 49. A metal grill 51, of expanded sheet steel, for example, is removably attached to a rectangular steel angle frame 52 bounding an aperture cut in the pan T2 or T4 for reception of the light fixture 46.

An emergency exit cutout is formed in the front-most top panel T5. The exit is closed by a door panel 56 that swings upwardly about hinges 57 welded or otherwise fixed to the web of the pan T5 as shown in FIG. 9. A slide bolt 58 releasable locks the door 56 in a closed position. A safety switch control arrangement signals the condition where the exit door panel 56 is open. The arrangement includes a switch base 58 fastened to the respective top panel T5. Switch contacts in the base 58 are closed, i.e. there is electrical continuity, when a plate-like contact key 59 is received in the base. The contact key 59 is insertable and removable from the switch base by vertical motion. The contact key 59 is connected to a portion of the door panel 56 that is remote from the hinges 57 by a flexible strand 61 in the form of a link chain. In order for the door panel 56 to be opened, the contact key 59 must be removed from the switch base 58 thereby signaling that the door is open. The flexible strand connection between the swingable end of the door panel 56 and the contact key 59 avoids any sensitivity of the switch function of the base 58 and key 59 to misalignment or distortion of the door panel 56 yet provides a reliable function of interlocking the door to the switch function.

It will be understood that the size of the cab 10 can be changed by adding or subtracting to the number of side and top pans and/or making changes in the size of the pans. In the illustrated case, the side pans B, R, L are nominally about 8 foot long. Where a double line opening cab is specified, the cab 10 can be modified principally by omitting the rear or back pans B1-6 and bottom and top angles BA2 and TA2.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An elevator cab having at least two sides and a top for mounting on a platform, the cab being formed of a plurality of elongated sheet metal pans, having opposed end edges and long side edges, the pans having a generally flat area between the side edges, the side edges each including a flange bent at right angles to the flat area, the flanges having spaced accircular holes, the generally flat area adjacent the end edges having holes, bottom angles for securing several of the pans forming walls of the cab to the platform, and top angles for securing several pans forming the walls to others of the pans forming a top of the cab, the bottom angles and top angles having accircular holes spaced to align with the holes in the flat end edge areas of the pans and bolts of a single size having square shank areas adapted to rotationally lock in the accircular holes of the angles and flanges, the bolts being assembled in the holes of the angles and the flat panel areas adjacent the panel end edges to fix the pans to the angles and being assembled in holes in the flanges of abutting pans to join the adjacent pans together.

2. An elevator cab comprising a plurality of elongated rectangular sheet metal pans and steel angles, the pans having opposed long edges and opposed short edges, the long edges of the pans being formed into flanges such that the pans have channel-shaped cross-sections, the area of the pans between the flanges being generally flat, some of the pans forming walls of the cab and others of the pans forming the top of the cab, a bottom steel angle at a bottom of each wall extending substantially along the width of such wall, the bottom angles being disposed on the inside of the cab, one leg of each bottom angle being arranged to be secured to the elevator platform and the other leg being secured to flat areas of the pans of its respective wall whereby the bottom angle of each wall serves to both align the panels of its wall to itself and to anchor its wall to the platform, a top steel angle at a top of each wall extending substantially across the full width of such wall, the top angles having a vertical leg on the inside of the cab and a horizontal leg extending over the short edges of the pans of their respective walls, the top angles each being bolted to each of the pans of its respective wall and serving to align such panels to itself, the panels forming the top of the cab overlying said top angles and being bolted to said top angles with bolts and nuts that are both accessible to a workman working on the top of said cab top.

3. An elevator cab as set forth in claim 2, wherein said pans and angles are bolted together with bolts and nuts of a common size.

4. A cab as set forth in claim 3, wherein said pans are bolted together with bolts and nuts common in size to those used to bolt said angles and pans together.

5. A cab as set forth in claim 3, wherein said angles are formed with accircular holes and said bolts have square shank portions adapted to rotationally lock in said accircular holes.

6. A cab as set forth in claim 5, wherein said pans are formed with accircular holes in their flanges and adjacent ones of said pans are bolted together with bolts and nuts that are the same in size as the bolts and nuts used with said angles and pans.

7. A cab as set forth in claim 6, wherein the top pans have flanges wider than the flanges of the wall panels.

8. A cab as set forth in claim 7, wherein at least one of said top pans has a rectangular cutout in its flat area and a rectangular light fixture is assembled with said one top pan above said cutout.

9. A cab as set forth in claim 8, wherein a sheet metal shield covers said light fixture, said shield being fixed on the flanges of said one pan.

10. A cab as set forth in claim 2, wherein said pans have a width that is about 1-½ feet such that adjacent ones of said pans forming said walls with their flanges extending outside of an interior of said cab can be progressively bolted together by a workman supported on the platform substantially in the space enclosed by said walls.

11. A cab as set forth in claim 2, wherein one of said top panels has an emergency exit cutout in its flat area, a door above said exit cutout, a safety switch on said emergency exit top pan, the switch being connected to said door by a flexible strand.

12. A cab as set forth in claim 11, wherein said door is hinged adjacent one edge and said flexible strand is attached to the door at a location remote from said one edge.
